(19) United States
(12) Patent Application Publication
(10) Pub. No.: US 2007/0050210 A1
(43) Pub. Date: Mar. 1, 2007

(54) Systems and Methods for Providing Pharmacy Discounts for Cash Customers While Maintaining Third-Party Reimbursement Rates

(76) Inventor: Joseph Lee Wiley II, Douglasville, GA (US)

Correspondence Address: SUTHERLAND ASBILL & BRENNAN LLP, 999 PEACHTREE STREET, N.E., ATLANTA, GA, 30309, US

(21) Appl. No.: 11/467,737

(22) Filed: Aug. 28, 2006

Related U.S. Application Data
(60) Provisional application No. 60/711,743, filed on Aug. 26, 2005.

(51) Int. Cl. G06F 15/18; G06Q 10/00

(52) U.S. Cl. 705/2; 706/1

(57) ABSTRACT

Embodiments of the present invention may allow for customer discount programs to be implemented for cash customers at one or more pharmacies. In particular, the customer discount programs may be implemented using switch-level transactions between one or more pharmacies and at least one switch provider, and without involvement of PBMs or other third-party payors. Under the customer discount programs, cash customers can be provided with discounts on prescription drug orders without lowering a pharmacy's usual and customary (U&C) prices or other prices upon which third-party reimbursement rates are based. Accordingly, the customer discount programs allow pharmacies to provide discounts to cash customers while maintaining their reimbursement rates on third party-contracts. Additionally, pharmacies that partner with a switch provider in providing these customer discount programs may be provided with rebates from the switch, which may offset at least a portion of the discounts provided to the cash customers. Therefore, embodiments of the present invention may involve receiving a prescription drug order associated with a cash customer from a pharmacy computer and applying program rules to the prescription drug order to determine a discount for the prescription drug order, where the program rules are associated with the customer discount program, determining a discounted price for the prescription drug order based at least in part on the determined discount, and transmitting the discounted price to the pharmacy computer.

### RELATED APPLICATIONS

The present invention claims benefit of U.S. Provisional Application Ser. No. 60/711,743, filed Aug. 26, 2005, and entitled “Systems and Methods for Providing Pharmacy Discounts for Cash Customers While Maintaining Third-Party Reimbursement Rates,” which is hereby incorporated by reference in its entirety.

### FIELD OF THE INVENTION

Aspects of an embodiment of the invention relate generally to pharmacy discounts and more particularly, to customer discount programs that provide cash customers with pharmacy discounts.

### BACKGROUND OF THE INVENTION

Cash customers are a very price-sensitive group of customers for pharmacies. These cash customers typically do not have the benefit of insurance or other third-party coverage or reimbursement for prescription drug costs. Because prescription drug costs may vary from pharmacy to pharmacy, these cash customers have been known to use several different pharmacies in order to fill their prescription drug needs at the lowest cost. A pharmacy would benefit significantly if these cash customers would fill all of their prescription needs at a single location.

Pharmacies face a perplexing problem when deciding whether to lower their usual and customary prices in order to attract more cash customers. While lowering their usual and customary prices may attract more cash customers, this may negatively affect the amount of third-party reimbursements received by pharmacies for non-cash customers. In particular, many third-party reimbursement rates are based on contracts that specify reimbursements based on the lower of negotiated rates or the pharmacy's usual and customary prices. Accordingly, the lowering of the pharmacy's usual and customary prices may limit the pharmacy to the usual and customary prices instead of the higher negotiated rates.

### SUMMARY OF THE INVENTION

According to an embodiment of the present invention, there is a computerized method for providing a customer discount program. The method includes receiving a prescription drug order associated with a cash customer from a pharmacy computer, and applying program rules to the prescription drug order to determine a discount for the prescription drug order, where the program rules are associated with the customer discount program. The method further includes determining a discounted price for the prescription drug order based at least in part on the determined discount and transmitting the discounted price to the pharmacy computer.

According to an aspect of the present invention, receiving a prescription drug order may include receiving the prescription drug order at a switch, and transmitting the discount price may include transmitting the discounted price from the switch. The program rules may also be stored for access by the switch prior to receiving the prescription drug order at the switch. According to another aspect of the present invention, the program rules may include discount rules associated with one or more prescription drugs. The discount rules may include at least one fixed amount or percentage discount for one or more prescription drugs. According to another aspect of the present invention, the method may further include recording a rebate amount associated with the received prescription drug order. According to yet another aspect of the present invention, the discounted price includes a transaction fee.

According to another embodiment of the present invention, there is a system for providing a customer discount program. The system includes a processor, a network interface in communication with the processor, and a memory in communication with the processor. The processor, the network interface, and the memory are collectively configured to receive a prescription drug order associated with a cash customer from a pharmacy computer, apply program rules to the prescription drug order to determine a discount for the prescription drug order, where the program rules are associated with the customer discount program, determine a discounted price for the prescription drug order based at least in part on the determined discount, and transmit the discounted price to the pharmacy computer.

According to an aspect of the present invention, the program rules may be stored in the memory. The memory may also include a database. According to another aspect of the present invention, the program rules may include discount rules associated with one or more prescription drugs. The discount rules may include at least one fixed amount or percentage discount for one or more prescription drugs. According to another aspect of the present invention, the processor, the network interface, and the memory may be further collectively configured to record a rebate amount associated with the received prescription drug order.

According to yet another embodiment of the present invention, there is a method of enhancing revenues for pharmacies. The method includes receiving program rules for a customer discount program, where the program rules specify at least an amount of discount for one or more prescriptions drugs, and receiving at least one prescription drug order for a cash customer from a pharmacy computer. The method further includes determining a price for the prescription drug order based at least in part on a discount provided for in the program rules for the customer discount program, and providing the determined price to the pharmacy computer.

According to another aspect of the present invention, the program rules may specify at least an amount of discount from a usual and customary (U&C) price for one or more prescription drugs. The amount of the discount may include at least one of a percentage discount or fixed discount. According to another aspect of the present invention, the program rules may specify at least an amount of discount for each category of drugs. The category of drugs may include generic drugs and brand-name drugs. According to still another aspect of the present invention, the method may further include recording a rebate amount for at least one received prescription drug order. According to yet another aspect of the present invention, the method may further include transmitting information associated with the prescription drug order to a manufacturer or a manufacturer clearing house to obtain at least one rebate.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of an interactive pharmacy system according to an illustrative embodiment of the invention.

FIGS. 2A and 2B illustrate exemplary flow diagrams for operation of the interactive customer discount program, according to illustrative embodiments of the present invention.

### DETAILED DESCRIPTION OF THE INVENTION

In accordance with embodiments of the present invention, customer discount programs directed to cash customers may be implemented by one or more pharmacies partnering with a switch provider. The switch provider provides a switch that interconnects the pharmacies with prescription benefits managers (PBMs) and other third-party payors. However, embodiments of the present invention may provide an efficient and centralized method of implementing these customer discount programs that does not involve the PBMs or other third-party payors. Further, when pharmacies transmit their prescription drug orders for cash customers to a switch for processing, the rules for these customer discount programs can be readily implemented on the switch.

Moreover, the customer discount programs in accordance with embodiments of the present invention can provide cash customers with discounts on prescription drug orders without lowering a pharmacy's usual and customary (U&C) prices or other prices upon which third-party reimbursement rates are based. Accordingly, the customer discount programs allow pharmacies to provide discounts to cash customers while maintaining their reimbursement rates on third party-contracts. Additionally, pharmacies that partner with a switch provider in providing these customer discount programs may be provided with rebates from the switch, which may offset at least a portion of the discounts provided to the cash customers.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described below with reference to block diagrams and flowchart illustrations of systems, methods, apparatuses and computer program products according to embodiments of the present invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

A. Overview of the Pharmacy System

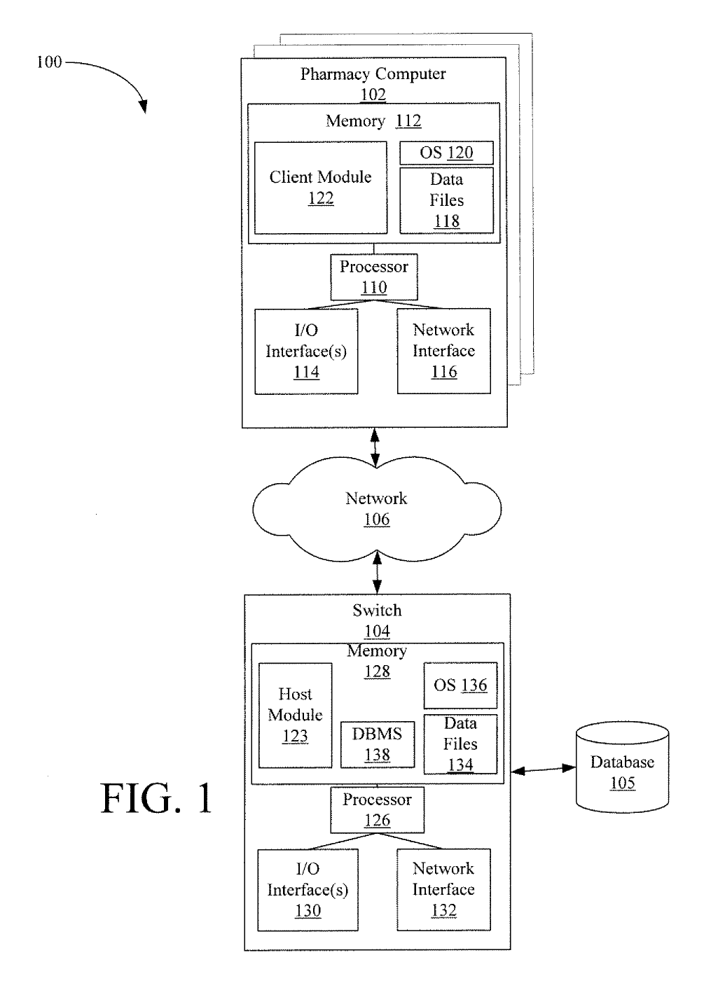

FIG. 1 shows a block diagram of an interactive pharmacy system 100 for implementing one or more customer discount programs, according to embodiments of the present invention. In particular, the interactive pharmacy system 100 of FIG. 1 includes at least one pharmacy computer 102 and at least one switch 104, which are each configured for accessing and reading associated computer-readable media having stored thereon data and/or computer-executable instructions for implementing the various methods of the present invention. Generally, network devices and systems, including the one or more pharmacy computers 102 and switches 104, have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

As shown in FIG. 1, a pharmacy computer 102 may be in communication with the switch 104 via a network 106, which as described below can include one or more private and public networks, including the Internet. Each of these three components—the pharmacy computer 102, the switch 104, and the network 106—will now be discussed in turn. First, the pharmacy computer 102 may be any processor-driven device, such as a personal computer, laptop computer, handheld computer, and the like. In addition to having a processor 110, the pharmacy computer 102 may further include a memory 112, input/output (“I/O”) interface(s) 114 and a network interface 116. The memory 112 may store data files 118 and various program modules, such as an operating system (“OS”) 120 and a client module 122. The client module 122 may be an Internet browser or other software, including a dedicated program, for interacting with the switch 104. For example, a pharmacist or other pharmacy employee may utilize the client module 122 in preparing and providing a prescription drug order to the switch 104 for processing. The pharmacy may also utilize the client module 122 to retrieve or otherwise receive data from the switch 104, including pricing and discount information for the prescription drug order.

Still referring to the pharmacy computer 102, the I/O interface(s) 114 facilitate communication between the processor 110 and various I/O devices, such as a keyboard, mouse, printer, microphone, speaker, monitor, bar code readers/scanners, REID readers, and the like. The network interface 116 may take any of a number of forms, such as a network interface card, a modem, a wireless network card, and the like. These and other components of the pharmacy computer 102 will be apparent to those of ordinary skill in the art and are therefore not discussed in more detail herein.

Second, similar to the pharmacy computer 102, the switch 104 may be any processor-driven device that is configured for receiving, processing, and fulfilling requests from the pharmacy computer 102 related to pharmacy, benefits, and/or discount transactions, including those associated with the customer discount program. The switch 104 may therefore include a processor 126, a memory 128, input/output (“I/O”) interface(s) 130 and a network interface 132. The memory 128 may store data files 134 and various program modules, such as an operating system (“OS”) 136, a database management system (“DBMS”) 138 and the host module 123. The host module 123 receives, processes, and responds to requests from the client module 122 of pharmacy computer 102. The switch 104 may include additional program modules for performing other pre-processing or post-processing methods described herein. Those of ordinary skill in the art will appreciate that the switch 104 may include alternate and/or additional components, hardware or software.

As illustrated in FIG. 1, the switch 104 may include or be in communication with one or more database(s) 105. If the switch 104 includes the database 105, then the database 105 could also be part of the memory 128. The database 105 and/or memory 128 may store, for example, program rules and transaction records, rebates, and/or discounts associated with prescription drug orders. The database 105 and/or memory 128 may also store identification information (e.g., name, address, social security number, membership number, member affiliation, etc.) for customers eligible for the customer discount program. Although a single database 105 is referred to herein for simplicity, those skilled in the art will appreciate that multiple physical and/or logical databases may be used to store the above mentioned data. For security and performance purposes, the switch 104 may have a dedicated connection to the database 105. However, the switch 104 may also communicate with the database 105 via a network 106, as shown. In other embodiments of the invention, the switch 104 may include the database 105 locally. The switch 104 may also otherwise be part of a distributed or redundant DBMS.

Third, the network 106 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. The network 106 may also allow for real-time, off-line, and/or batch transactions to be transmitted between the pharmacy computer 102 and the switch 104. Due to network connectivity, various methodologies as described herein may be practiced in the context of distributed computing environments. Although the pharmacy computer 102 is shown for simplicity as being in communication with the switch 104 via one intervening network 106, it is to be understood that any other network configuration is possible. For example, intervening network 106 may include a plurality of networks, each with devices such as gateways and routers for providing connectivity between or among networks 106. Instead of or in addition to a network 106, dedicated communication links may be used to connect the various devices of the present invention.

Those of ordinary skill in the art will appreciate that the pharmacy system 100 shown in and described with respect to FIG. 1 is provided by way of example only. Numerous other operating environments, system architectures, and device configurations are possible. Accordingly, the present invention should not be construed as being limited to any particular operating environment, system architecture, or device configuration.

B. Operation of the Pharmacy System

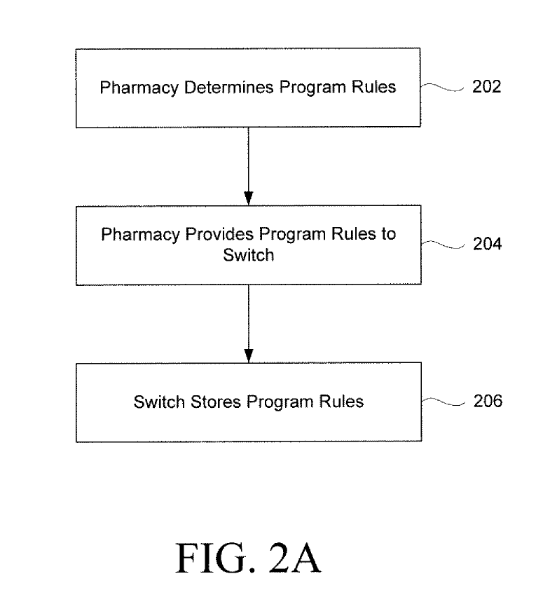

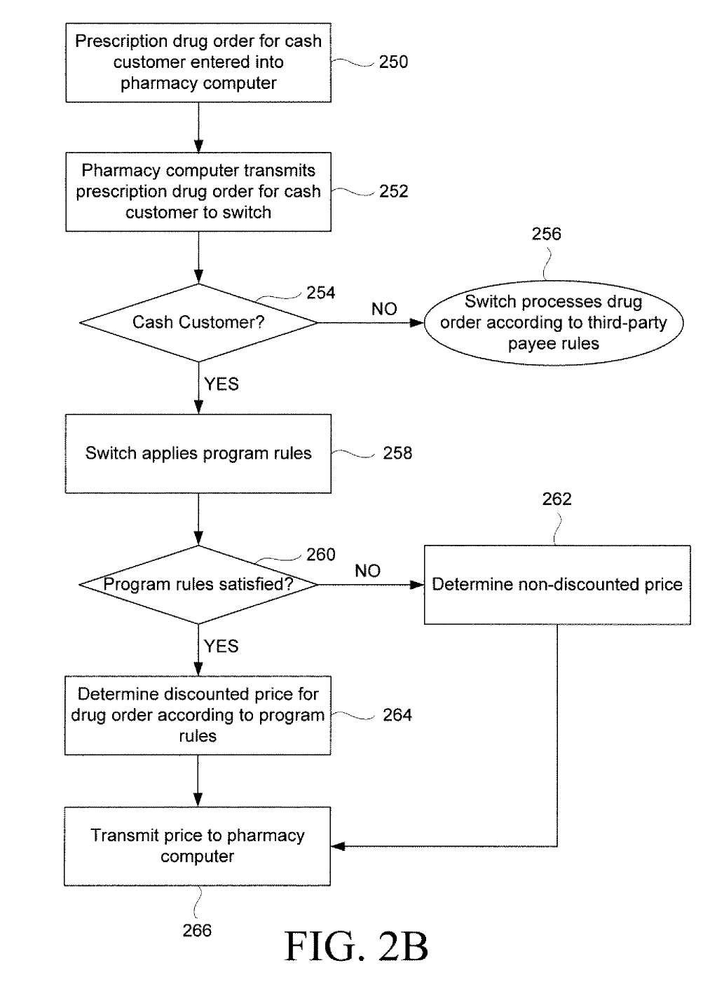

The pharmacy system 100 may allow for customer discount programs to be provided for cash customers at one or more pharmacies. The customer discount programs may provide discounts for cash customers at pharmacies as well as associated rebates for the pharmacies themselves. These rebates may allow the pharmacy to offset at least a portion of the discounts provided to the cash customers under the customer discount program. The operation of the pharmacy system 100 of FIG. 1 will now be with reference to FIGS. 2A and 2B.

With reference to FIG. 2A, the pharmacy may specify or otherwise determine program rules and/or criteria in accordance with the customer discount programs that are to be implemented via the pharmacy system 100, and in particular, the switch 104 (block 202). These program rules may specify one or more of (i) discount (and/or discount type) rules, (ii) eligibility rules for certain prescription drugs, (iii) identification rules for identifying whether one or more cash customers or prescription drug orders are eligible under the customer discount program for discounts, and (iv) pricing rules for membership in the customer discount program. Other rules may also be implemented in accordance with the customer discount program.

First, the discount (and/or discount type) rules described above may specify one or more rules for discount amounts, which may take the form of a particular percentage or a fixed amount off the price for one or more prescription drugs. The discount amounts may be based upon the usual and customary (U&C) price for the prescription drugs according to an exemplary embodiment of the present invention. Second, the eligibility rules introduced above may include rules for determining whether the discount amounts should be applied to certain prescription drugs. In particular, the eligibility rules may include identifying one or more drug classifications and/or age groups for the discount amounts. The drug classifications may be for generic dugs, brand-name drugs, over-the-counter (OTC) drugs, or a combination thereof. Further, the drug classifications may be for only certain brands of drugs, certain classes of drugs, certain combinations of drugs, or certain ones of drugs. For example, the discount amount for generic drugs may be ten percent (10%) while the discount amount for brand-name drugs may be fifteen percent (15%) according to an exemplary embodiment of the invention. Likewise, the discount amount may be five percent (5%) for a first brand-name drug and ten percent (10%) for a second brand-name drug. Additionally or alternatively, the one or more discount amounts may be applied for particular age groups. For example, one or more discount amounts may be applied to prescription drug orders for seniors who are older than 65 years according to an exemplary embodiment. Similarly, one or more discount amounts may be applied for infants and children under 5 years of age. One of ordinary skill in the art will also recognize that discounts may be applied utilizing factors other than drug categories and age groups.

Third, the program rules may also include rules and associated information for identifying whether one or more customers or prescription drug orders are eligible for the discounts. According to an aspect of the present invention, these rules may determine that a customer is eligible based at least in part upon a prescription drug order being associated with a cash payment option or otherwise being submitted to a specified BIN at the switch 104. In addition or in the alternative, a customer may be eligible based at least in part upon enrollment in the customer discount program The customer discount program may resemble or be included as part of a store's shopping/rewards or incentive program. Likewise, a customer may be eligible based at least in part upon verification of membership in another organization, such as the American Association of Retired Persons (AARP). Additionally, the customer may be eligible based at least in part on being specifically identified or listed (e.g., by name, social security number, etc.) as eligible in the database 105 and/or memory 128 of the switch 104. Alternatively, the switch 104 may access a remote database 105 for determining customer eligibility for the customer discount program.

Fourth, the program rules may include pricing rules for membership in the customer discount program. According to an embodiment of the present invention, the pharmacy may charge a membership fee to the customers under the terms of the customer discount program. This membership fee may be charged on a one-time or periodic basis, and the pricing rules may include verifying whether the membership fee has been paid. Alternative, the membership fee may be charged on a per transaction basis in which case the pricing rules may specify the membership fee amount to be charged with the prescription drug order. In this situation, the membership fee can be a fixed amount or it can be a percentage of the price (e.g., the U&C price or the discounted price) for the prescription drug order. Of course, the membership fee could also be levied on a one-time, multi-time, or periodic basis in conjunction with a per-transaction fee.

Referring back to FIG. 2A, once the program rules for the cash customers have been determined by the pharmacy, the pharmacy provides these program rules to the switch 104 (block 204). According to one embodiment of the present invention, the pharmacy may provide the program rules in a digital format operable with the switch 104. For instance, the pharmacy may provide the program rules to the switch 104 over network 106 via a computer, such as pharmacy computer 102. As described above, the program rules can include one or more of discount rules, eligibility rules, identification rules, and pricing rules. According to an exemplary embodiment of the present invention, the pharmacy can also provide as part of or in addition to the program rules, a listing of identification information for cash customers eligible under the customer discount program. The switch 104 then stores the program rules in database 105 and/or memory 128. In another embodiment of the present invention, the pharmacy may communicate the program rules to the switch 104 provider, which may then program or otherwise configure the switch 104 accordingly. According to an embodiment of the invention, the switch 104 may be the Intelligent Network provided by Per-Sé® Technologies, although another switch 104 may be utilized without departing from embodiments of the present invention. While not shown in FIG. 1, the switch 104 may also be connected to third-party payors, which may include insurers, managed care organizations, prescription benefit managers (PBMs), and governmental organizations such as Medicare and Medicaid. However, in accordance with an embodiment of the present invention, the customer discount program may be implemented by the switch 104 without necessarily requiring interactions between the third-party payors and the switch 104.

Referring now to FIG. 2B, an exemplary prescription order for a cash customer at a pharmacy will now be described with the operation of the program rules provided to the switch 104 according to FIG. 2A. In accordance with an embodiment of the invention, an exemplary prescription drug order may be entered into the pharmacy computer 250 by a pharmacist or other pharmacy employee for a cash customer (block 250). The pharmacy may include the cash customer's information with the prescription drug order, including the customer's identification information (e.g., name, address, birthday, etc.) and age information. Of course, the pharmacy may also specify the prescription drug that is to be filled by the order. The prescription drug order may also be designated as a cash customer transaction (e.g., perhaps being identified for transmittal to a particular BIN). The prescription drug order would then be provided by the pharmacy computer 102 to the switch 104 (block 252).

Once the switch 104 receives the prescription drug order, the switch 104 determines whether the prescription drug order is associated with a cash customer (block 254). The switch 104 may make this determination based upon a designation provided by the pharmacy computer 102. For instance, a field of the prescription drug order may specifically indicate a cash customer. Alternatively, the prescription drug order may have been designated for a particular BIN associated with cash customer transactions. Additionally, the lack of a third-party payee information may denote a cash customer. If the switch 104 determines that the prescription drug order is not associated with a cash customer, then the drug order may be processed by the switch 104 according to the third-party payee reimbursement procedures, which may be provided according to a contract (block 256). On the other hand, if the switch 104 determines that the prescription drug order is indeed associated with a cash customer, then the switch 104 may apply program rules associated with the customer discount program to the received drug order (block 258). As shown in block 260, the switch 104 may determine one or more of whether the program rules are satisfied in order for the customer to receive a discount on at least a portion of the prescription drug order. In particular, the switch 104 may determine one or more of the discount types, the eligibility of the drugs in the drug order for the discount types, whether the cash customer is an eligible cash customer under the customer discount program, and the customer discount program fees for the cash customer. As indicated above, the discount amount may be determined based at least in part on the category that the prescription drug falls under and/or the cash customer's age group.

If the program rules for the customer discount program are not satisfied (block 260)—that is, the cash customer is not eligible for any discount under the discount program, then the switch 104 determines the price to be provided for the prescription drug order (block 262). On the other hand, if the program rules are satisfied (block 260)—that is, the cash customer is eligible for at least one discount under the discount program, then the switch 104 determines a discounted price to be provided for the prescription drug order (block 264). According to an exemplary embodiment of the present invention, this discounted price may be a discount (e.g., fixed amount or percentage) off of the usual and customary (U&C) price for the prescription drug. This discounted price could also be determined based at least in part on the average wholesale price (AWP). In addition, the discounted price may further include a small transaction fee for a prescription order for a cash customer participating in the customer discount program. In an exemplary embodiment of the invention, the transaction fee may be between approximately five and thirty cents for each transaction processed under the program. One of ordinary skill in the art will recognize that a wide range of fees may be utilized without departing from the embodiments of the present invention. In alternative variations of the present invention, the discounted price may not include the transaction fee. Instead, the pharmacy may add the transaction fee after receiving the discounted price from the switch 104. The prices determined according to blocks 262 or 264 are then transmitted by the switch 104 back to the pharmacy computer 102 (block 266).

While blocks 250-266, have been described in the order shown in FIG. 2B, other embodiments of the present invention may vary the ordering of the blocks—for example, block 260 may be presented before block 254 (along with accompanying variations to the dependent blocks) without departing from the present invention. Further, other embodiments of the present invention may combine or separate the blocks or otherwise provide additional intervening blocks.

In addition to determining the price to be charged for the cash customer's prescription order (block 266), the switch 104 may also facilitate the handling of rebates for prescription orders. In other words, the pharmacy may qualify for a rebate for submitting prescription drug orders for cash customers to the switch 104 under the customer discount program. In particular, these switch 104 interactions relating to prescription orders for cash customers may be submitted by the switch 104 provider to one or more manufacturers or manufacturer clearing houses to obtain rebates. In accordance with an embodiment of the invention, pharmacies may be provided wit the benefit of at least a portion of these rebates (“rebate amounts”). Indeed, the switch 104 may accrue rebate amounts for the pharmacies as prescription drug orders are processed by the switch 104. For example, the rebate amounts may be stored in the database 105 or the memory 128 associated with the switch 104, perhaps upon the successful processing a received prescription drug order for a cash customer. The rebate amounts for the pharmacies may be predetermined amounts. For example, according to an aspect of the invention, pharmacies may receive fifty-cent rebates for each prescription order for cash customers under the program. Alternatively, according to another aspect of the invention, the rebate amounts may vary depending upon the type of prescription drug order that is filled. That is, certain ones of drugs may have a higher associated rebate amount than other drugs. In any event, pharmacies may be able to book or record the rebate amounts as rebate revenues in the period in which they are earned or accrued.

In accordance with an embodiment of the present invention, the switch 104 may accumulate rebate amount information in its database 105 and/or memory 128 for completed prescription drug orders for cash customers. This accumulated rebate amount information may be provided to the pharmacies participating in the customer discount program via a variety of communication means. For example, the pharmacy computer 102 may obtain the accumulated rebate information from the switch 104 or switch 104 provider via e-mail, fax, or direct communications via network 106.

One of ordinary skill in the art will recognize that when implementing the customer program for cash customers, the switch 104 does not necessarily need to communicate with the insurers or other third-party payors. This may allow significant flexibility and efficiency when compared to the process involving pharmacy benefit manager systems (PBMs). With PBMs, the switch 104 communicates the prescription drug orders to the insurers or third-party payors. The insurer or third-party payors then provide the amount that customers may be charged on their orders. If any discounts are provided, these discounts are typically based on the average wholesale price (AWP) instead of through the pharmacy's usual and customary (U&C) price. By contrast, the customer programs in accordance with embodiments of the present invention allow pharmacies to control their usual and customary prices while still providing significant discounts to their cash customers. This allows pharmacies to increase revenues from cash customers while still maintaining third-party contract reimbursements that otherwise may be affected by lower usual and customary prices.

C. Exemplary Implementations of the Customer Discount Program

1. New Patients/Prescriptions Mode

According to an exemplary embodiment of the present invention, a pharmacy may choose to participate in a customer discount program. The exemplary discount program may provide cash customers with the following discount from the usual and customary (U&C) price: a 5% discount for brand-name drugs and a 10% generics. In addition, an exemplary $0.10 transaction fee will be levied by switch 104 provider on the pharmacy, which will be similarly passed onto the customer for submission of a prescription drug order under the customer discount program. Further, a $0.50 rebate will be available to the pharmacy for each prescription drug order submitted under the customer discount program.

According to a brand-name drug example, assuming that the U&C price of a brand-name drug is $75, the discounted price of the drug under the customer discount program will be $71.35 ($75*0.95=$71.25+$0.10 transaction fee=$71.35). Accordingly, the customer would save $3.65 from the U&C price under the discount pharmacy program. On the other hand, the pharmacy would realize $71.75 ($71.35 revenue+$0.50 rebate−$0.10 transaction fee−$71.75). In this situation, the pharmacy would stand to lose $3.25 from the U&C price. However, if the profit margin for the brand-name drug is 10%, then the pharmacy would actually make an additional $7.63 in revenue at a cost of $3.65 for each additional brand-name prescription gained. In particular, at a selling price of $71.25 (excluding the $0.10 transaction fee), the profit margin dollars would be $7.125. The rebate provided by the switch 104 provider would be $0.50 for a total gross profit margin of $7.625.

According to a generic drug example, assuming that the U&C price of a generic drug is $25, the discounted price of the drug under the customer discount program will be $22.60 ($25*0.90=$22.50+$0.10 transaction fee $22.60). The customer would save $2.40 from the U&C price under the discount pharmacy program. On the other hand, the pharmacy would realize $23.00 ($22.60 revenue+$0.50 rebate−$0.10 transaction fee=$23.00). In this situation, the pharmacy would stand to lose $2.00 from the U&C price. However, if the profit margin for the generic drug is 60%, then the pharmacy would actually make an additional $14.50 in revenue at a cost of $0.50 for each additional brand-name prescription gained. In particular, at a selling price of $22.50 (excluding the $0.10 transaction fee), the profit margin dollars would be $13.50. The rebate provided by the switch 104 provider would be $0.50 for a total gross profit margin of $14.00.

According to a blended example, assume that the blended (e.g., average) U&C price of the generic and name-brand drugs is $45 and the blended discount percentage for both the generic and name-brand drugs is 10%. According to this example, the blended discounted price for the customer would be $40.65 ($45.00*0.90=$40.50+$0.10 transaction free=$40.65). The customer would save an average of $4.15 per prescription drug for his or her generic and brand-name drugs. On the other hand, the pharmacy would realize an average of $41.00 ($40.65+0.50 rebate−$0.10 transaction fee=$41.00). The pharmacy would stand to lose an average of $4.00 per prescription from the U&C price. However, if the profit margin for the blended drug example is 35%, then the pharmacy would actually make an additional $15.18 in revenue at a cost of $3.95 for each additional brand-name prescription gained. In particular, at a selling price of $40.50 (excluding the $0.10 transaction fee), the profit margin dollars would be $14.18. The rebate provided by the switch 104 provider would be $0.50 for a total gross profit margin of $14.68.

2. Modest Savings to Customer Mode

According to an exemplary customer discount program, the pharmacy may choose to provide a slight decrease in the U&C price to a cash customer while preserving a net gain in revenue and margin dollars for the average transaction. The exemplary customer discount program may provide 1% off of the U&C price for both brand-name drugs and generic drugs. The rebate paid to the pharmacy would be $0.50 and the transaction fee of $0.10 would be passed to the cash customer. The U&C price for brand-name and generic drugs would be $75 and $25, respectively. The blended average price in the market for the prescription would be $40-$45.

According to the brand-name drug example, assuming that the U&C price of a brand-name drug is $75, the discounted price of the drug under the customer discount program will be $74.35 ($75*0.99=$74.25+$0.10 transaction fee=$74.35). Accordingly, the customer would save $0.65 from the U&C price under the discount pharmacy program. On the other hand, the pharmacy would realize $74.75 ($74.35 revenue+$0.50 rebate−$0.10 transaction fee=$74.75). In this situation, the pharmacy would stand to lose $0.25 from the U&C price.

According to a generic drug example, assuming that the U&C price of a generic drug is $25, the discounted price of the drug under the customer discount program will be $24.85 ($25*0.99=$24.75+$0.10 transaction fee=$24.85). The customer would save $0.15 from the U&C price under the discount pharmacy program. On the other hand, the pharmacy would realize $25.25 ($24.85 revenue+$0.50 rebate−$0.10 transaction fee=$25.25). In this situation, the pharmacy would gain $0.25 from the U&C price.

According to a blended example, assume that the blended (e.g., average) U&C price of the generic and name-brand drugs is $45 and the blended discount percentage for both the generic and name-brand drugs is 1%, According to this example, the blended discounted price for the customer would be $44.65 ($45.00*0.99=$44.55+$0.10 transaction free=$44.55). The customer would save an average of $0.35 per prescription drug for his or her generic and brand-name drugs. On the other hand, the pharmacy would realize an average of $45.05 ($44.65+0.50 rebate−$0.10 transaction fee=$45.00). The pharmacy would stand to gain an average of $0.05 per prescription from the U&C price.

3. Reduction of Third-Party Paid at U&C Mode

In the reduction of third-party paid at U&C mode, the pharmacy may already have a low U&C price in order to capture a larger percentage of the cash market. In order to gain in this market, the pharmacy suffers from a high number of claims being paid a lower amount from third party payors due to contractual language that typically states that reimbursement is at the lower of U&C or the negotiated AWP-X %+Dispensing Fee.

The customer discount program allows the pharmacy to create a managed plan from their cash customer base. Because the cash customer must pay (e.g., a transaction fee) in order to participate, and given that the pharmacy controls the parameters of the plan (e.g., discount from U&C, age requirements, drug Categories, etc.), the pharmacy can raise its U&C prices for the drug categories that are reducing third-party reimbursements by a specific percentage while providing this same percentage discount for the same drug category to its members of the customer discount program. Under this discount pharmacy program, the net effect is no increase in price to the members of the customer discount program—perhaps all cash customers—while increasing the U&C submitted to the third party payors.

As an example, a pharmacy may be paid at the U&C price for an average of 15% (e.g., 1500 claims per month@$75 avg. claim U&C) of its third-party claims. The pharmacy determines that it could reduce this incidence to 5% if it were to increase its U&C prices by 10% for brand-name drugs. However, the pharmacy has not increased the U&C prices because its desires to continue to be the low price leader in its market for these drugs. However, if the pharmacy were to activate all of its cash customers in a customer discount program, then it could raise the overall IU&C prices by 10% on brand-name drugs while simultaneously setting the parameters of the customer discount program to provide a 10% discount from the U&C prices. The net effect would be a submitted U&C average price of $82.50 to the third party payors and an average reduction from this of $8.25 to the customer discount program members. This will result in a higher reimbursement from the third party payors and a net effect to the customer of $0.65 or 0.1% decrease in price ($0.10 is the transaction fee). In addition to the increase in revenue from the third party payors, the pharmacy would also get a $0.50 in manufacturer rebate revenue from the switch provider under the discount pharmacy program. This will give the pharmacy a net reduction in revenue from the cash patient of $0.25. While a specific discount was recited above, one of ordinary skill will recognize that the pharmacy could set the discount at a variety of different points to balance the impact between customer costs and the pharmacy revenues.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computerized method for providing a customer discount program, comprising:
receiving a prescription drug order associated with a cash customer from a pharmacy computer;
applying program rules to the prescription drug order to determine a discount for the prescription drug order, wherein the program rules are associated with the customer discount program;
determining a discounted price for the prescription drug order based at least in part on the determined discount; and
transmitting the discounted price to the pharmacy computer.

2. The method of claim 1, wherein receiving a prescription drug order includes receiving the prescription drug order at a switch, and wherein transmitting the discount price includes transmitting the discounted price from the switch.

3. The method of claim 2, further including storing the program rules for access by the switch prior to receiving the prescription drug order at the switch.

4. The method of claim 1, wherein the program rules include discount rules associated with one or more prescription drugs.

5. The method of claim 4, wherein the discount rules include at least one fixed amount or percentage discount for one or more prescription drugs.

6. The method of claim 1, further including recording a rebate amount associated with the received prescription drug order.

7. The method of claim 1, wherein the discounted price includes a transaction fee.

8. A system for providing a customer discount program, comprising:
a processor;
a network interface in communication with the processor; and
a memory in communication with the processor, wherein the processor, the network interface, and the memory are collectively configured to:
receive a prescription drug order associated with a cash customer from a pharmacy computer;
apply program rules to the prescription drug order to determine a discount for the prescription drug order, wherein the program rules are associated with the customer discount program;
determine a discounted price for the prescription drug order based at least in part on the determined discount; and
transmit the discounted price to the pharmacy computer.

9. The system of claim 8, wherein the program rules are stored in the memory.

10. The system of claim 8, wherein the memory includes a database.

11. The system of claim 8, wherein the program rules include discount rules associated with one or more prescription drugs.

12. The system of claim 11, wherein the discount rules include at least one fixed amount or percentage discount for one or more prescription drugs.

13. The system of claim 8, wherein the processor, the network interface, and the memory are further collectively configured to record a rebate amount associated with the received prescription drug order.

14. A method of enhancing revenues for pharmacies, comprising:
receiving program rules for a customer discount program, wherein the program rules specify at least an amount of discount for one or more prescriptions drugs;
receiving at least one prescription drug order for a cash customer from a pharmacy computer;
determining a price for the prescription drug order based at least in part on a discount provided for in the program rules for the customer discount program; and
providing the determined price to the pharmacy computer.

15. The method of claim 14, wherein the program rules specify at least an amount of discount from a usual and customary (U&C) price for one or more prescription drugs.

16. The method of claim 14, wherein an amount of the discount includes at least one of a percentage discount or fixed discount.

17. The method of claim 14, wherein the program rules specify at least an amount of discount for each category of drugs.

18. The method of claim 17, wherein the category of drugs includes generic drugs and brand-name drugs.

19. The method of claim 14, further including recording a rebate amount for at least one received prescription drug order.

20. The method of claim 14, further including transmitting information associated with the prescription drug order to a manufacturer or a manufacturer clearing house to obtain at least one rebate.
